(19) United States
(12) Patent Application Publication
(10) Pub. No.: US 2014/0000525 A1
(43) Pub. Date: Jan. 2, 2014

(54) CLUMPING AGENT

(71) Applicants: Joseph Schumski, Maumee, OH (US); Frank Butwin, Maumee, OH (US)

(72) Inventors: Joseph Schumski, Maumee, OH (US); Frank Butwin, Maumee, OH (US)

(73) Assignee: The Andersons, Inc., Maumee, OH (US)

(21) Appl. No.: 13/932,871

(22) Filed: Jul. 1, 2013

Related U.S. Application Data
(60) Provisional application No. 61/666,519, filed on Jun. 29, 2012.

(51) Int. Cl. A01K 1/015; C08K 3/34; C08K 3/22; C08L 3/00; C08K 3/26; C08K 3/38; C08L 1/28

(52) U.S. Cl. CPC A01K 1/0154; C08K 3/38; C08K 3/346; C08L 1/286; C08L 3/00; C08K 3/26; C08K 3/22
USPC 119/173; 106/501.1; 106/487

(57) ABSTRACT

A clumping agent composition is provided that includes a pre-gelled starch divided to a starch size with at least 70% by weight of said starch being −200 mesh. An polyoxygenated moiety is present and includes at least one of borax, bicarbonate, or aluminate. The starch and the polyoxygenated moiety combined to form the clumping agent composition with a rapid build of viscosity when wet. A litter is formed when the clumping agent composition is present from 1 to 10 total weight percent decorating the surface of a particulate. Divided carboxymethylcellulose is included in some embodiments along with the starch and the oxygenated moiety.

### RELATED APPLICATIONS

This application claims priority benefit of U.S. Provisional application Ser. No. 61/666,519 filed Jun. 29, 2012; the contents of which are hereby incorporated by reference.

### FIELD OF THE INVENTION

The present invention in general relates in general to clumping agents and in particular to a finely divided clumping agent formulated through a combination of pre-gelled starch and an inorganic polyoxygenated moiety.

### BACKGROUND OF THE INVENTION

Clumping agents are used for adhering particulate matter in response to absorbing moisture or liquid. A common example of the use of clumping agents is that of animal litter, were in response to contact with animal urine or secretions the litter absorbs the liquid and the clumping agent forms a grouping or clump of litter material for removal and disposal. Clumping agents may also be used for chemical spill clean ups and removal. Clays have long been used in this application on the basis of high water absorption to form clumps that are structurally amenable to separation. However, clays have become disfavored in many settings owing to the high density, sulfate leaching and the tendency to foul piping. In response to these limitations, the prior art has resorted to various types of starches, gums, and cellulose as an alternative to clay.

As these alternative materials become gelatinous through hydration of polymeric chains as opposed to water adhering to clay surfaces and intercalating between clay platelets, different loadings of carbohydrate based polymeric clumping agents are required to achieve an overall clumping effect similar to that of clays.

Guar gum has been a preferred component of clumping agents. Clumping agents composed of guar gum have a clump durability of at least 95%. However, in recent years increased demand for guar gum primarily from the oil industry for use in drilling and by the natural gas industry for use in the hydraulic fracturing process for sourcing natural gas has caused created a shortage of guar gum for a variety of applications including usage in animal litter. Other gums such as xanthans, and other mannose based gums provide varying degrees of room temperature gelation and also suffer from shortages. Starches and celluloses have had lesser success as a clumping agents or gelling agents in settings where high clump strength and high water absorption capacity as a function of agent weight are required.

Thus, there exists a need for a clumping agent composition that provides acceptable clump durability performance without the need to resort to clays or shortage prone gums. There further exists a need for a clumping agent composition that is based on starches that achieve high performance clumping.

### SUMMARY OF THE INVENTION

A clumping agent composition is provided that includes a pre-gelled starch divided to a starch size with at least 70% by weight of said starch being −200 mesh. An polyoxygenated moiety is present and includes at least one of borax, bicarbonate, or aluminate. The starch and the polyoxygenated moiety combined to form the clumping agent composition with a rapid build of viscosity when wet. A litter is formed when the clumping agent composition is present from 1 to 10 total weight percent decorating the surface of a particulate. Divided carboxymethylcellulose is included in some embodiments along with the starch and the oxygenated moiety.

### DETAILED DESCRIPTION OF THE PREFERRED EMBODIMENTS

The present invention has utility as a clumping agent operative in a variety of settings including animal litters, foodstuffs, pharmaceuticals and nutraceuticals, oil and gas extraction, personal care products, and concrete castings. An inventive composition is formulated from a combination of a finely divided water swellable starch and a borate, carbonate, or a combination thereof. In certain embodiments, a cellulose component is present. With intending to be bound to a particular theory, the cellulose component is believed to facilitate a rapid build in clump strength, after which the starch component begins to build clump strength. In certain embodiments, the inventive clumping agent when present with a substrate material as an litter or absorbed for spills provides clump durability of at least 95%. Embodiments of the inventive clumping agent are operative independent of the use of guar gum and other shortage prone gums while maintaining the required clumping durability. In still other embodiments of the present invention such gums are used in lesser quantities along with the inventive starch. Embodiments of the inventive clumping agent may be used in paints, food products, animal litter products, as well as in injection fluids for the oil service and natural gas industry. The surprisingly high degree of gelation and clump durability of the present invention is based on the discovery that in addition to the chemical properties of the starch and cellulose used herein, these components must be finely divided to a size below that commonly manufactured and used.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

As used herein, water swellable is defined as a material absorbing more than 5 percent of the dry material weight in liquid water 500 micron particle after 1 hour.

As used herein, finely divided composition components of starch are defined as having at least 70% by weight passing a −200 mesh screen size, in other embodiments more than 80% by weight of the starch component passes a −200 mesh screen and preferably 95% by weight of the starch component passes a −200 mesh screen. In certain embodiments such an animal litter, the clump durability as measured by the Goldstein clump strength test method is at least of 90%, and more preferably 95%. It is appreciated that these clump durability values are achieved by adjusting the swelling properties of the starch and cellulose components, as well as the quantity of inventive clumping agent relative to substrate particulate of for example an animal litter.

As used herein, finely divided composition components of cellulose are defined as having at least 70% by weight passing a −80 mesh screen size, in other embodiments more than 70% by weight of the cellulose component passes a −200 mesh screen and preferably 95% by weight of the cellulose component passes a −200 mesh screen.

An inventive clumping agent composition regardless of whether it contains additional optional ingredients has the ability to absorb 0.1 parts by weight water per part by weight of inventive clumping composition as measured by pre-weighing the composition on a dry and after contact with water and subsequent draining of free water from the resultant gel. In other embodiments the inventive composition is able to absorb between 0.3 and 2 parts by weight water per part by weight of inventive clumping composition.

Without intending to be bound to a particular theory, the high degree of clumping achieved by the present inventive is believed to result from chemical changes that occur through the division of the starch and cellulose components to the sizes used in the present invention. The finely divided materials of the clumping agent are formed by milling or grinding followed by screening. Milling or grinding to a size distribution is readily accomplished with a commercially available milling machine, hammer mill, pin mill, knife mill, air mill, or pulverizer. A Champion hammer milling machine (Waterloo, Iowa) is representative of such a milling machine. It should be appreciated that these techniques impart transiently high mechanical forces and thermal inputs to the starch and cellulose starting materials. Starch in particular is known to have a complex form with crystalline and amorphous regions, as well as varying amounts of amylose. One of skill in the art appreciates that in general the higher the amylose content, the lower is the swelling power and the lower is the gel strength for the same starch concentration.

A starch component of an inventive clumping agent is selected to have at least a degree of cold water solubility prior to being finely divided. Cold water solubility is typically imparted through chemical modification, pre heating, or a combination thereof. Starches operative herein with a degree to cold water solubility illustratively include modified starches with the corresponding European Commission food additive numbers of E1400 Dextrin, E1401 Modified starch (Acid treated starch), E1402 Alkaline modified starch, E1403 Bleached starch, E1404 Oxidized starch, enzyme treated starch, E1410 Monostarch phosphate, E1412 Distarch phosphate, E1413 Phosphated distarch phosphate, E1414 Acetylated distarch phosphate, E1420 Acetylated starch, mono starch acetate, E1421 Acetylated starch, mono starch acetate, E1422 Acetylated distarch adipate, E1430 Di starch glycerine, E1440 Hydroxy propyl starch, E1441 Hydroxy propyl distarch glycerine, E1442 Hydroxy propyl distarch phosphate, E1450 Starch sodium octenyl succinate, E1451 Acetylated oxidized starch and combinations thereof. It is appreciated that pre-heating imparts a degree of cold water solubility to any of the aforementioned that is enhanced by the division process used in the present invention. Subsequent drying of pre-heated starch occurs with resort to techniques such as extrusion, drum drying or spray drying. It is appreciated that the gelatinization temperature of starch depends upon plant type and the amount of water present, pH, types and concentration of salt, sugar, fat and protein in the recipe, as well as derivatization technology used. Some types of unmodified native starches start swelling at 55° C., other types at 85° C. The gelatinization temperature depends on the degree of cross-linking of the amylopectin, and can be modified by genetic manipulation of starch synthase genes or chemical modification as detailed above. During gelatinization, water acts as a plasticizer. Water is first absorbed in the amorphous space of starch, which leads to a swelling phenomenon during heating and then transmitted through connecting molecules to crystalline regions. Water enters tightly bound amorphous regions of double helical structures to swell amylopectin, thus causing crystalline structures to melt and break free. Stress caused by this swelling phenomenon eventually interrupts structure organization and allows for leaching of amylose molecules to surrounding water. During gelatinization of starch three main processes happen to the starch granule: granule swelling, crystal or double helical melting, and amylose leaching. Gelatinization improves the availability of starch for amylase hydrolysis. As a result such pre-gelled starches are used in inventive embodiments where a rapid build of clump strength is required.

The nature of the base starch prior to chemical modification or heating and drying as detailed above or subjected to pre-gel treatment illustratively includes wheat, corn, potato, rice tapioca, sweet potato, sago, and mung bean. In a specific inventive embodiment, pre-gelatinized potato starch is used a starch component for further division for usage in an inventive composition. Regardless of the specific nature of the starch component of an inventive composition, the finely divided starch component is present from 10 to 90 percent by weight of an inventive clumping agent composition. In other embodiments, the finely divided starch component is present from 15 to 97 percent by weight of an inventive clumping agent composition.

It has been found that the inclusion of an inorganic polyoxygenated moiety of borax (disodium tetraborate), bicarbonate (hyhdrogen carbonate (HCO₃⁻), sodium aluminate, or a combination thereof is present. Without intending to be bound by a particular theory, it is believed the borate or carbonate moiety crosslinks with the hydroxyl moieties of the starch to build viscosity. The polyoxygenated moiety is typically present from 3 to 85 total weight percent of the clumping agent, while in specific embodiments, the polyoxygenated moiety is present from 5 to 25 total weight percent of the clumping agent. The sizing of the polyoxygenated moiety is less import owing to the water solubility thereof.

A cellulose component operative in an inventive clumping agent composition also has a degree of water solubility prior to being finely divided for use in the present invention and is present in some embodiments of the present invention. Celloluses used herein illustratively include cellulose esters such as cellulose formate, acetate, propionate, butyrate, valerate, caproate, heptylate, caprate, laurate, myristate and palmitate obtained by reaction with organic acids, anhydrides or acid chlorides; cellulose ethers derived from the reaction of cellulose with alkylating agents such as chloroacetic acid and alkylene oxides under basic conditions. Specific cellulose ethers operative herein illustratively include, carboxymethyl celluloses (CMC) such as anionic sodium carboxymethylcellulose (ASCMC) and nonionic hydroxyethylcellulose (HEC) and HEC modified with a long chain alkyl group, i.e. HMHEC(Hydrophobically Modified HEC), methylcellulose, ethylcellulose, hydroxyethylcellulose, hydroxy-methylethylcellulose, hydroxyethylpropylcellulose, and methylhydroxyethyl-cellulose.

It has been found that celluloses with a viscosity of greater than 5,000 centipoise (cps) and in still other embodiments between 10,000 and 50,000 cps are well suited for usage in an inventive composition. Such celluloses are then finely divided as detailed above to achieve an increased degree of clumping ability and gelation of water as compared to an equivalent weight of conventional, coarse sized cellulose.

In a specific embodiment pre-gel modified potato starch has been found to absorb more water than other types of starches, and CMC absorbs more water than guar gum when equally sized according to the present invention of greater than 70% by weight of each milled to be −200 mesh (smaller than 74 micron particle size). The combination of pre-gel modified potato starch and CMC provides a high degree clump durability compared to guar gum at like loadings. The finely divided cellulose component is present from 0 to 70 percent by weight of an inventive clumping agent composition. In the simplest version of the present invention, the cellulose makes up the remainder to the composition relative to the starch component and polyoxygenated moiety.

In certain embodiments, the performance of the clumping agents is enhanced inclusion of dust control agent (DCA) such as a vegetable or petroleum based oil may be used to control potential dust from the find grinds of a base inventive, and to tack the clumping agent on to the surface of the base material. Other optional additives include conventional clumping agents such as guar gum or clay; fragrances; pH indicators; dyes; pigments; inert fillers; baking soda; xanthan gum, locust bean gum, bentonite clays, and combinations thereof.

The use of a biobased inventive clumping agent offers several advantages. Biobased materials are renewable resources and are particularly suited to potentially lowering the carbon footprint, and are suitable for composting, and therefore have the potential to lessen landfill burdens and fouling of sewage and other piping systems.

To produce a clumping animal litter according to the present invention, the clumping agent is first dispersed in an oil, and in some instances with a non-ionic emulsifier present along with the polyoxygenated moiety. The resulting dispersion is then distributed, e.g., by spraying, over a particulate material conventional to litters so as to provide a desired clumping agent concentration on the particulate substrate.

Suitable litter particulates illustratively include cellulosics such as corn cob, stover, wheatstraw, saw dust, tree bark, dried distillers grain, peanut shells, grain hulls, nut shells, citrus fruit peels, and straws; clays; gravels; diatomaceous earths; and combinations thereof.

The clumping agent is typically present in an amount in the range of 0.2% to 10% by weight, based upon the weight of the substrate particles. In other embodiments, the clumping agent is distributed on the litter substrate particles in an amount in the range of 1% to 10% by weight, based on the total litter weight. The oil, if present, is present in the range of 4 to 6 total weight percent along with the optional non-ionic emulsifier. It is appreciated that an inventive clumping agent is also readily adhered to particulate through the tack of binder associated the substrate particulate or even incorporated into the substrate particulate through a pan agglomeration process.

High loading of inventive clumping agent composition dispersed throughout substrate particulate finds particular utility is spill remediation and hydrocarbon extraction.

The present invention is further detailed with respect to the following examples. These examples are intended so illustrate specific inventive compositions and their surprising properties compared to comparative compositions. These examples should not be construed to limit the scope of the appended claims or otherwise limit the nature of the present invention.

### EXAMPLE 1

80 parts by weight of pre-gel modified potato starch is milled to a 95% weight percent −200 mesh with no starch particulate having a particle size of greater 80 mesh. This finely divided starch is combined with 20 parts by weight of 16,000 cps carboxymethylcellulose (CMC) that is milled to a 95% weight percent −200 mesh with no CMC particulate having a particle size of greater 80 mesh. This clumping agent composition is coated onto a corn cob particulate substrate having an average size of between 12 and 20 mesh at 5% total weight with a carrier of mineral oil at 4.8% total weight of the composition. 25 grams of water is added to a 3 inch thick bed of litter to simulate urination. The clump durability as measured by the Goldstein clump strength test method has an average of 96% and a maximal value of 98% at 15 minutes.

### EXAMPLE 2

The composition of Example 1 is reproduced with E1401 starch that is also subjected to preheating to for a pre-gel modified wheat starch in place of the potato starch is added to a litter per Example 1. 25 grams of water is added to a 3 inch thick bed of litter to simulate urination. The clump durability has an average of 92% and a maximal value of 96% at 15 minutes.

### EXAMPLE 3

The clumping agent of Example 1 is coated onto the corn cob particulate at 4% total weight with a carrier of mineral oil at 4.1% total weight of the composition. 25 grams of water is added to a 3 inch thick bed of litter to simulate urination. The clump durability has an average of 91% and a maximal value of 94% at 15 minutes.

### EXAMPLE 4

The clumping agent of Example 1 is coated onto the corn cob particulate at 10% total weight with a carrier of mineral oil at 4.8% total weight of the composition. 25 grams of water is added to a 3 inch thick bed of litter to simulate urination. The clump durability has an average of 96% and a maximal value of 99% at 15 minutes.

### EXAMPLE 5

90 parts by weight of pre-gel modified potato starch is milled to a 95% weight percent −200 mesh with no starch particulate having a particle size of greater 80 mesh. This finely divided starch is combined with 10 parts by weight of borax that is milled to a 95% weight percent −80 mesh. This clumping agent composition is coated onto a corn cob particulate substrate having an average size of between 12 and 20 mesh at 5% total weight with a carrier of mineral oil at 4% total weight of the composition. 25 grams of water is added to a 3 inch thick bed of litter to simulate urination. The clump durability as measured by the Goldstein clump strength test method has an average of 96% and a maximal value of 98% at 15 minutes.

### COMPARATIVE EXAMPLE A

Guar gum having 95% weight percent −200 mesh with no guar being larger than 80 mesh is coated onto a corn cob particulate substrate at 5% total weight with a carrier of mineral oil at 4.8% total weight of the composition. 25 grams of water is added to a 3 inch thick bed of litter to simulate urination. The clump durability as measured by the Goldstein clump strength test method has an average of 97% and a maximal value of 99% at 15 minutes.

### COMPARATIVE EXAMPLE B

Unmodified potato starch with 95% weight percent −200 mesh with no potato starch being larger than 80 mesh is coated onto a corn cob particulate substrate at 5% total weight with a carrier of mineral oil at 4.8% total weight of the composition. 25 grams of water is added to a 3 inch thick bed of litter to simulate urination. The clump durability as measured by the Goldstein clump strength test method has an average of 30% and a maximal value of 47%.measured at 15 minutes.

### COMPARATIVE EXAMPLE C

Pre-gel modified potato starch with an average size of 400 microns is coated onto a corn cob particulate substrate at 5% total weight with a carrier of mineral oil at 4.8% total weight of the composition. 25 grams of water is added to a 3 inch thick bed of litter to simulate urination. The clump durability as measured by the Goldstein clump strength test method has an average of 70% and a maximal value of 84%.measured at 15 minutes.

### COMPARATIVE EXAMPLE D

Molasses is coated onto a corn cob particulate substrate at 5% total. 25 grams of water is added to a 3 inch thick bed of litter to simulate urination. The clump durability as measured by the Goldstein clump strength test method has an average of 30% and a maximal value of 54% measured at 15 minutes.

1. A clumping agent composition comprising:
a starch divided to a starch size with at least 70% by weight of said starch being −200 mesh;
an oxygenated moiety including at least one of borax, bicarbonate, or aluminate; said starch and said oxygenated moiety combined to form the clumping agent composition.

2. The composition of claim 1 wherein said starch is pre-gelatinized modified potato starch.

3. The composition of claim 1 wherein said starch has at a minimum 80% by weight −200 mesh.

4. The composition of claim 1 wherein said starch has at a minimum 95% by weight passing a −200 mesh.

5. The composition of claim 1 further comprising a cellulose, wherein said cellulose is at least one of ethylcellulose, hydroxyethylcellulose, hydroxy-methylethylcellulose, hydroxyethylpropylcellulose, methylhydroxyethyl-cellulose, or methylcellulose.

6. The composition of claim 1 wherein said cellulose is a carboxymethylcellulose.

7. The composition of claim 1 wherein said starch has a degree of cold water solubility prior to being divided.

8. The composition of claim 1 wherein said starch is present from 10 to 90 total weight percent of the composition.

9. The composition of claim 1 wherein said clumping agent has a clump durability of at least 95%.

10. The composition of claim 1 further comprising at least one of a dust control agent guar gum, clay, fragrance, a pH indicator, a dye, a pigment, an inert filler, xanthan gum, locust bean gum, or combinations thereof.

11. The composition of claim 1 where said oxygenated moiety is borax.

12. A clumping agent composition comprising:
pre-gelatinized starch having a starch size with at least 70% by weight of said starch being −200 mesh;
an oxygenated moiety including at least one of borax, bicarbonate, or aluminate; and
carboxymethyl cellulose (CMC) divided to a CMC size of more than 80% by weight of said cellulose being −80 mesh, said starch, said oxygenated moiety, and said CMC combined to form the clumping agent composition.

13. The composition of claim 12 wherein both said pre-gelatinized starch and said CMC are finely ground to a minimum of a −80 sieve size.

14. The composition of claim 12 wherein said pre-gelatinized starch and said CMC have at a minimum 80% by weight passing a −200 mesh.

15. The composition of claim 12 wherein said pre-gelatinized starch and said CMC have at a minimum 95% by weight passing a −200 mesh.

16. The composition of claim 12 wherein said clumping agent has a clump durability of at least 95%.

17. A litter comprising:
a particulate substrate having a surface; and
a composition according to claim 1 decorating the surface.

18. The litter of claim 17 wherein the composition is present from 1 to 10 total % by weight.

19. The litter of claim 18 wherein said particulate substrate is corn cob.

20. The litter of claim 18 wherein said particulate substrate is wood particulate.
